(19) United States
(12) Patent Application Publication
(10) Pub. No.: US 2014/0129744 A1
(43) Pub. Date: May 8, 2014

(54) METHOD AND SYSTEM FOR AN IMPROVED I/O REQUEST QUALITY OF SERVICE ACROSS MULTIPLE HOST I/O PORTS

(71) Applicants: Kishore Kumar Muppirala, Bangalore (IN); Senthil R. Kumar, Bangalore (IN); Vasundhara Gurunath, Bangalore (IN)

(72) Inventors: Kishore Kumar Muppirala, Bangalore (IN); Senthil R. Kumar, Bangalore (IN); Vasundhara Gurunath, Bangalore (IN)

(21) Appl. No.: 14/126,840

(22) PCT Filed: Jul. 6, 2011
(86) PCT No.: PCT/IN2011/000449

§ 371 Date: Dec. 16, 2013

(51) Int. Cl. G06F 13/16

(52) U.S. Cl. CPC G06F 13/1642
USPC 710/39

(57) ABSTRACT

A method and system for an improved input/output (I/O) request quality of service (QoS) across multiple host I/O ports are disclosed. In one example, an I/O request associated with a classification parameter is received. The I/O request is generated by one of a plurality of host servers. Further, a classification value is determined based on the classification parameter by a host tagging agent residing one of the plurality of host servers. Furthermore, the classification value is associated with the I/O request by the host tagging agent. In addition, the I/O request is prioritized based on the classification value by a host port queuing manager and a host QoS controller. Based on the priority, the I/O request is sent to one of a plurality of target devices by the host port queuing manager and the host QoS controller.

### BACKGROUND

With increasing amounts of data being created, stored, retrieved and searched, need for storage networks is growing exponentially. Further, with such data explosion, adoption of storage area networks (SANs) is also increasing rapidly. SANs enable storage consolidation and sharing among multiple servers and workloads hosted on them. Furthermore, increasing adoption of virtualization technologies in the data centers is another trigger for storage devices to be shared by multiple virtual machines (VMS) and workloads hosted within them. In such a scenario, quality of service (QoS) or adherence to service level agreements (SLAs), for multiple and often competing workloads that share the storage devices becomes essential.

Various technologies are used to deliver QoS, typically, at the server-end, the storage device-end, or in the SAN infrastructure (such as SAN switches). Of the three techniques, delivering QoS at storage device-end is the most widely used. One such existing technique employs a “class of service to storage device location mapping” to present virtual logical unit numbers (LUNs) that have high/medium/low performance as their attribute. However, this technique fails to provide SLA guarantees, such as minimum throughput and/or maximum latency. Another existing technique supports throughput and latency control delivered at the storage device-end. However, this technique may not differentiate input/outputs (I/Os) originating from different applications when they are using the same LUN or LUN group in a disk array. Yet another existing technique which delivers QoS at a network level is effective for bandwidth capping, however, may not deliver latency SLAs. Yet another existing technique delivers application level QoS with latency and bandwidth goals on a same storage device. This technique deploys a scheduling algorithm aided by an I/O classifier embedded in the I/O request frames originating from the servers, where the applications that generate I/O requests have a QoS associated with them. However, this technique is deployed in disk array firmware and hence is disk array specific and may not be deployable across different servers and storage devices from different vendors.

### BRIEF DESCRIPTION OF THE DRAWINGS

Various embodiments are described herein with reference to the drawings, wherein:

FIG. 1 illustrates a flow diagram of a method for an improved input/output (I/O) request quality of service (QoS) across multiple host I/O ports, according to an embodiment;

FIG. 2 illustrates a block diagram of a system for the improved I/O request QoS across multiple host I/O ports using the process shown in FIG. 1, according to an embodiment;

FIG. 3 illustrates a block diagram of a host server operating system stack layer used in the system, such as the one shown in FIG. 2, according to an embodiment;

FIG. 4 is a block diagram illustrating elements in host port queuing managers realized in each interface driver in the host device operating system, such as those shown in FIG. 3, according to an embodiment;

FIG. 5 illustrates another block diagram of a system for the improved I/O request QoS across multiple host I/O ports using the process shown in FIG. 1, according to an embodiment;

FIG. 6 illustrates a block diagram of a host server operating system stack layer used in the system, such as the one shown in FIG. 5, according to an embodiment;

FIG. 7 is a block diagram illustrating elements in host port queuing managers realized in each host I/O ports, such as those shown in FIG. 6, according to an embodiment; and

FIG. 8 illustrates graphs of latency results of I/O requests plotted against time when using the improved I/O request quality of service (QoS) across multiple host I/O ports, such as those shown in FIGS. 2 and 5, according to an embodiment.

The drawings described herein are for illustration purposes only and are not intended to limit the scope of the present disclosure in any way.

### DETAILED DESCRIPTION

Method and system for an improved input/output (I/O) request quality of service (QoS) across multiple host I/O ports are disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

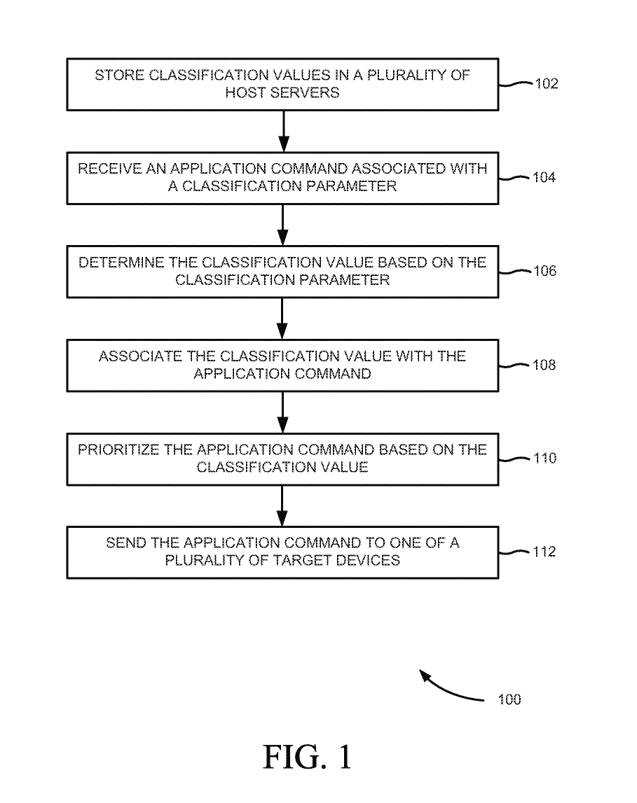

FIG. 1 illustrates a flow diagram 100 of a method for the improved I/O request QoS across multiple host I/O ports, according to an embodiment. At block 102, classification values are stored by a QoS manager in a plurality of host severs for I/O requests associated with a classification parameter. At block 104, an I/O request associated with a classification parameter is received. In one embodiment, the I/O request is generated by one of the plurality of host servers. At block 106, a classification value is determined based on the classification parameter by a host tagging agent residing in the one of the plurality of host servers. In this embodiment, the classification value is determined based on the classification parameter and a previous classification value assigned to the I/O request by the host tagging agent.

At block 108, the classification value is associated with the I/O request by the host tagging agent. At block 110, the I/O request is prioritized based on the classification value by a host port queuing manager and a host QoS controller. In one embodiment, the I/O request is prioritized based on the classification value by the host port queuing manager residing in one of a plurality of interface drivers in an operating system of the one of the plurality of host servers. In another embodiment, the I/O request is prioritized based on the classification value by the host port queuing manager residing in one of a plurality of host I/O ports in the one of the plurality of host servers.

At block 112, the I/O request is sent to one of a plurality of target devices based on the priority by the host port queuing manager and the host QoS controller. Exemplary target devices include storage devices, network devices, processors and the like. Further, the I/O request is sent to one of the plurality of target devices via a storage area network (SAN) based on the priority by the host port queuing manager and the host QoS controller.

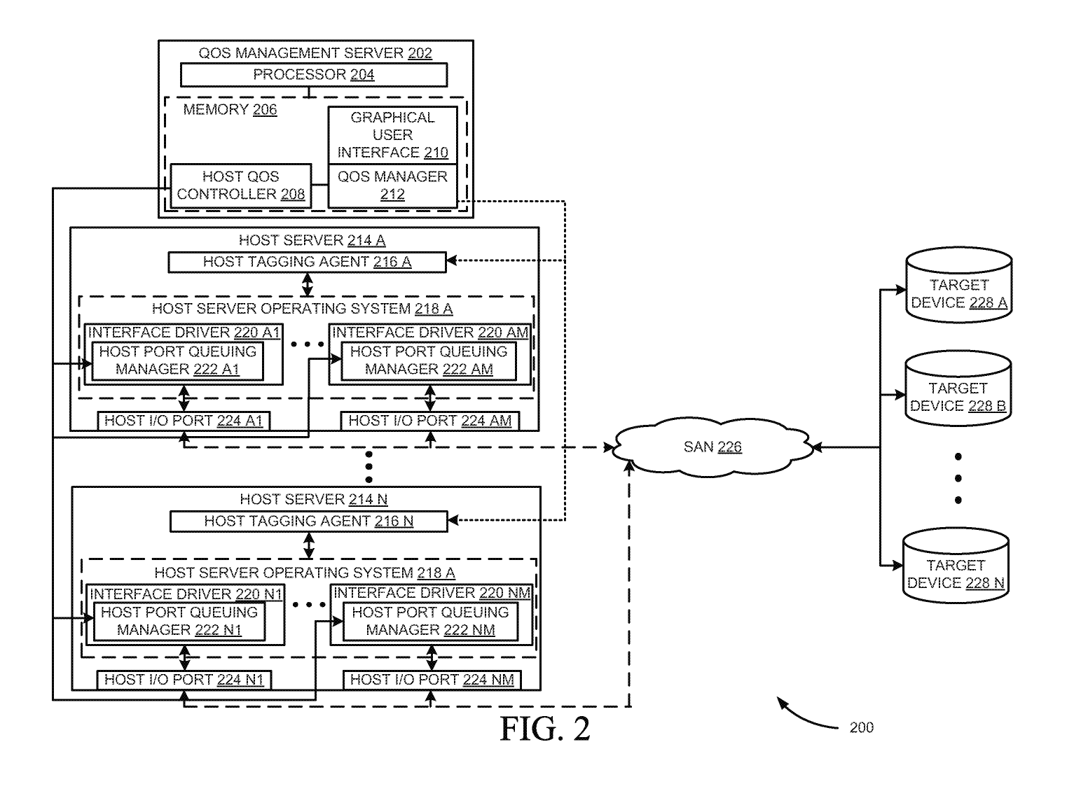

Referring now to FIG. 2, a block diagram illustrates a system 200 for the improved I/O request QoS across multiple host I/O ports using the process shown in FIG. 1, according to an embodiment. Particularly, FIG. 2 illustrates a QoS management server 202, a plurality of host servers 214 A-N and a plurality of target devices 228 A-N. Exemplary target devices include storage devices, network devices, processors and the like. As shown in FIG. 2, the plurality of host servers 214 A-N are coupled to the plurality of target devices 228 A-N via a storage area 006Eetwork (SAN) 226.

Further as shown in FIG. 2, the QoS management server 202 includes a processor 204 and a memory 206 coupled to the processor 204. Furthermore as shown in FIG. 2, the memory 206 includes a host QoS controller 208, a graphical user interface 210 and a QoS manager 212. In addition as shown in FIG. 2, each of the host servers 214 A-N includes a processor and a memory coupled to the processor. The memory associated with each of the host servers 214 A-N includes an associated one of host tagging agents 216 A-N and an associated one of host server operating systems 218 A-N. Moreover as shown in FIG. 2, each of the host server operating systems 218 A-N in the associated one of the host servers 214 A-N includes associated plurality of interface drivers 220 A1-AM to 220 N1-NM, respectively. Also, each of the plurality of interface drivers 220 A1-AM to 220 N1-NM in the host server operating systems 218 A-N, respectively, is coupled to an associated host I/O port. As shown in FIG. 2, each of the plurality of interface drivers 220 A1-AM in the host server 214 A is coupled to an associated one of the host I/O ports 224 A1-AM. Further as shown in FIG. 2, each of the plurality of interface drivers 220 N1-NM in the host server 214 N is coupled to an associated one of host I/O ports 224 N1-NM.

In one embodiment, each of the plurality of interface drivers 220 A1-AM to 220 N1-NM in the host servers 214 A-N, respectively, includes a host port queuing manager. As shown in FIG. 2, each of the plurality of interface drivers 220 A1-AM in the host server 214 A includes an associated one of host port queuing managers 222 A1-AM. Further as shown in FIG. 2, each of the plurality of interface drivers 220 N1-NM in the host server 214 N includes an associated one of host port queuing managers 222 N1-NM. Furthermore as shown in FIG. 2, the host QoS controller 208 in the QoS management server 202 is coupled to each of the host port queuing managers 222 A1-AM to 222 N1-NM in the host servers 214 A-N, respectively. For example, the host QoS controller 208 is coupled to each of the host port queuing managers 222 A1-AM to 222 N1-NM in the host servers 214 A-N, respectively, using transport control protocol/internet protocol (TCP/IP). In addition as shown in FIG. 2, the QoS manager 212 in the QoS management server 202 is coupled to each of the host tagging agents 216 A-N in the host servers 214 A-N, respectively. For example, the QoS manager 212 is coupled to each of the host tagging agents 216 A-N in the host servers 214 A-N, respectively, using TCP/IP.

In operation, one of the host servers 214 A-N generates an I/O request associated with a classification parameter. In one embodiment, an application in the one of the host servers 214 A-N generates the I/O request, where the application is associated with a QoS service level agreement (SLA). The classification parameter associated with the I/O request identifies the workload and the SLA associated with the application. Further, the one of the host tagging agents 216 A-N in the associated one of the host servers 214 A-N receives the I/O request associated with the classification parameter.

In order to deliver the required QoS for the application, the associated one of the host tagging agents 216 A-N determines a classification value based on the classification parameter. The classification value acts as the QoS level descriptor and is used to classify the I/O request based on the classification parameter associated with the I/O request. Exemplary classification value can include a tag value, a virtual port number and the like.

In one embodiment, the QoS manager 212 determines and stores a set of classification values associated with each of the host tagging agents 216 A-N in the host servers 214 A-N, respectively. Further, the I/O request generated by the one of the host servers 214 A-N is associated with a classification value from the set of classification values associated with the corresponding one of the host tagging agents 216 A-N. For example, an I/O request generated by the host server 214 A is associated with one of the classification values associated with the host tagging agent 216 A. In this embodiment, the one of the host tagging agents 216 A-N determines a classification value for the I/O request based on the classification parameter and a previous classification value assigned to the I/O request from the application. Further in operation, the classification value is associated with the I/O request by the one of the host tagging agents 216 A-N.

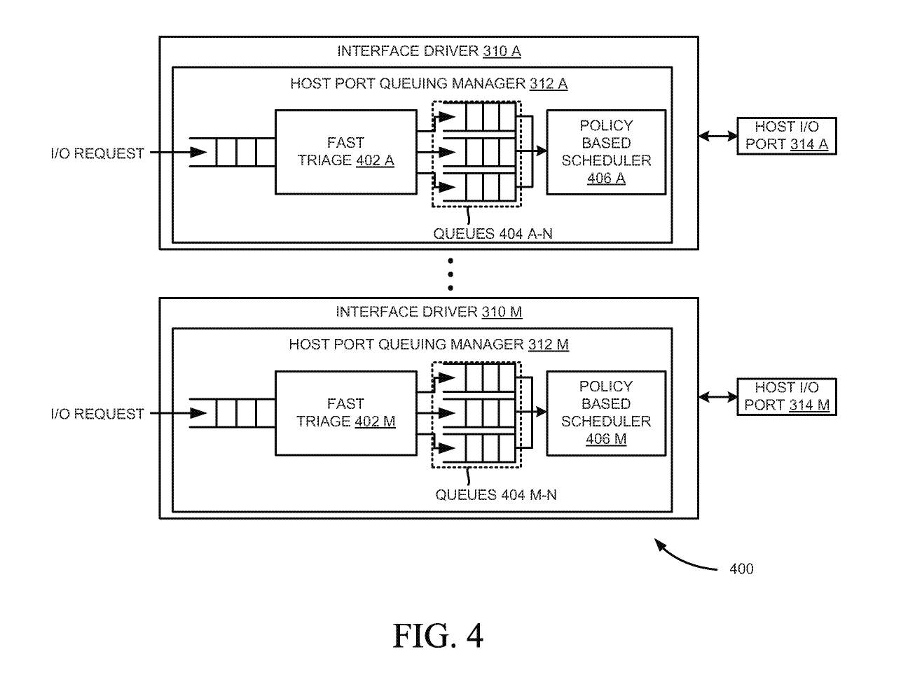

Furthermore in operation, based on the classification value associated with the I/O request, one of the host port queuing managers 222 A1-AM to 222 N1-NM in the associated one of the host servers 214 A-N, respectively, and the host QoS controller 208 prioritizes the I/O request. For example, the I/O request generated by the host server 214 A is prioritized by one of the host port queuing managers 222 A1-AM and the host QoS controller 208. In addition, in operation, based on the priority the I/O request is queued and scheduled to be serviced in the associated one of the host port queuing managers 222 A1-AM to 222 N1-NM in the associated one of the host servers 214 A-N, respectively. This is explained in more detail with reference to FIG. 4. In this embodiment, the host QoS controller 208 in the QoS mar rent server 202 controls the host port queuing managers 222 A1-AM to 222 N1-NM in the host servers 214 A-N, respectively, in order to deliver the required QoS SLA across the host servers 214 A-N.

Also in operation, the I/O request is sent to one of the plurality of target devices 228 A-N by the associated one of the host port queuing managers 222 A1-AM to 222 N1-NM in the associated one of the host servers 214 A-N, respectively. Moreover, the I/O request is sent to one of the plurality of target devices 228 A-N via the associated one of the host I/O ports 224 A1-AM to 224 N1-NM in the associated one of the host servers 214 A-N, respectively, through the SAN 226.

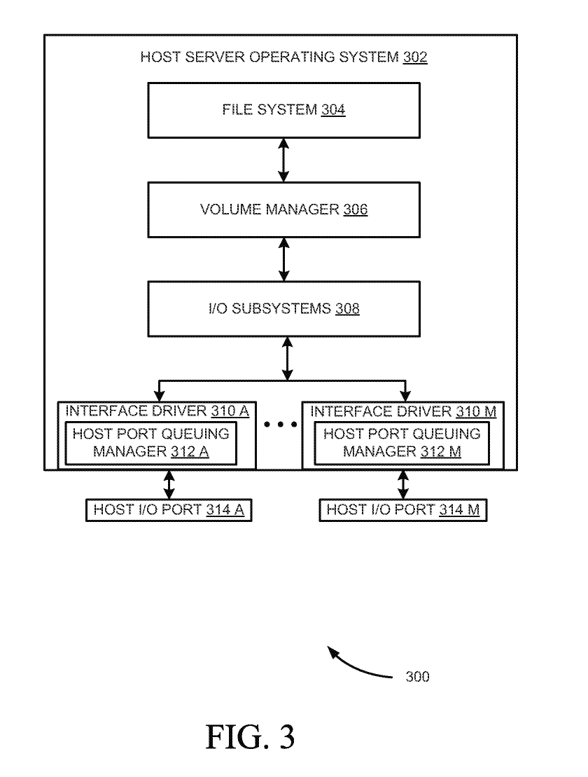

Referring now to FIG. 3, a block diagram 300 illustrates a host server operating system 302 stack layer used in the system, such as the one shown in FIG. 2, according to an embodiment. Each of the host server operating systems 218 A-N in the host servers 214 A-N, respectively, shown in FIG. 2, includes a host server operating system stack layer similar to the host server operating system 302 stack layer, shown in FIG. 3. As shown in FIG. 3, the host server operating system 302 stack layer includes a file system 304, a volume manager 306, I/O subsystems 308 and interface drivers 310 A-M. Exemplary I/O subsystems include drivers, multi-path layers and the like. Further as shown in FIG. 3, each of the interface drivers 310 A-M is coupled to one of host I/O ports 314 A-M. In this embodiment, each of the interface drivers 310 A-M includes one of host port queuing managers 312 A-M, as shown in FIG. 3. However, one can envision, the host port queuing managers 312 A-M being implemented in the file system 304, or volume manager 306 or the I/O subsystems 308.

In operation, an I/O request is generated by an application in a host server associated with the host server operating system 302. In some embodiments, the I/O request can be generated by the file system 304, the volume manager 306 or the I/O subsystems 308. The generated I/O request is sent to one of the interface drivers 310 A-M. The one of the host port queuing managers 312 A-M in the associated one of the interface drivers 310 A-M queues and schedules the I/O request for service. Further, the I/O request is queued and scheduled based on the SLA requirement of the application which generated the I/O request. This is explained in more detail with reference to FIG. 4.

Referring now to FIG. 4, a block diagram 400 illustrates elements in the host port queuing managers 312 A-M realized in the interface drivers 310 A-M, respectively, in the host server operating system 302, such as those shown in FIG. 3, according to an embodiment. Each of the host port queuing managers 222 A1-AM to 222 N1-NM in the host servers 214 A-N, shown in FIG. 2, includes elements similar to the elements in the host port queuing managers 312 A-M, shown in FIG. 4. Particularly, FIG. 4 illustrates the interface drivers 310 A-M coupled to the associated one of the host I/O ports 314 A-M. As shown in FIG. 4, each of the interface drivers 310 A-M includes the associated one of the host port queuing managers 312 A-M. Further as shown in FIG. 4, each of the host port queuing managers 312 A-M includes an associated one of fast triages 402 A-M, associated plurality of queues 404 A-N to 404 M-N and an associated one of policy based schedulers 406 A-M.

In operation, an I/O request associated with a classification value is received by the one of the interface drivers 310 A-M. This is explained in more detail with reference to FIG. 2. The associated one of the fast triages 402 A-M in the one of the interface drivers 310 A-M identifies the classification value associated with the I/O request and classifies the I/O request. Based on the classification, the I/O request is sent into one of the queues in the associated one of the plurality of queues 404 AN to 404 M-N. For example, an I/O request received by the fast triage 402 A in the host port queuing manager 312 A is classified based on the classification value associated with the I/O request and sent into one of the queues 404 A-N.

Further in operation, the queues 404 A-N to 404 M-N are controlled by the policy based schedulers 406 A-M, respectively. Furthermore in operation, the policy based schedulers 406 A-M are controlled by the host QoS controller 208, shown in FIG. 2. In order to achieve a required SLA for the application generating the I/O request, in one embodiment, the host QoS controller 208 skews the policy based schedulers 406 A-M. For example, parameters associated with the policy based schedulers 406 A-M are changed to achieve the required SLA. Furthermore in operation, the policy based schedulers 406 A-M controls the release rate of the I/O request in the queues 404 A-N to 404 M-N, respectively. In addition in operation, the policy based schedulers 406 A-M releases the I/O request from the queues 404 A-N to 404 M-N, respectively, based on the classification value associated with the I/O request. Moreover in operation, the I/O request is released into the associated one of the host I/O ports 314 A-M. The I/O request is then sent to the associated one of the target devices 228 A-N to be serviced.

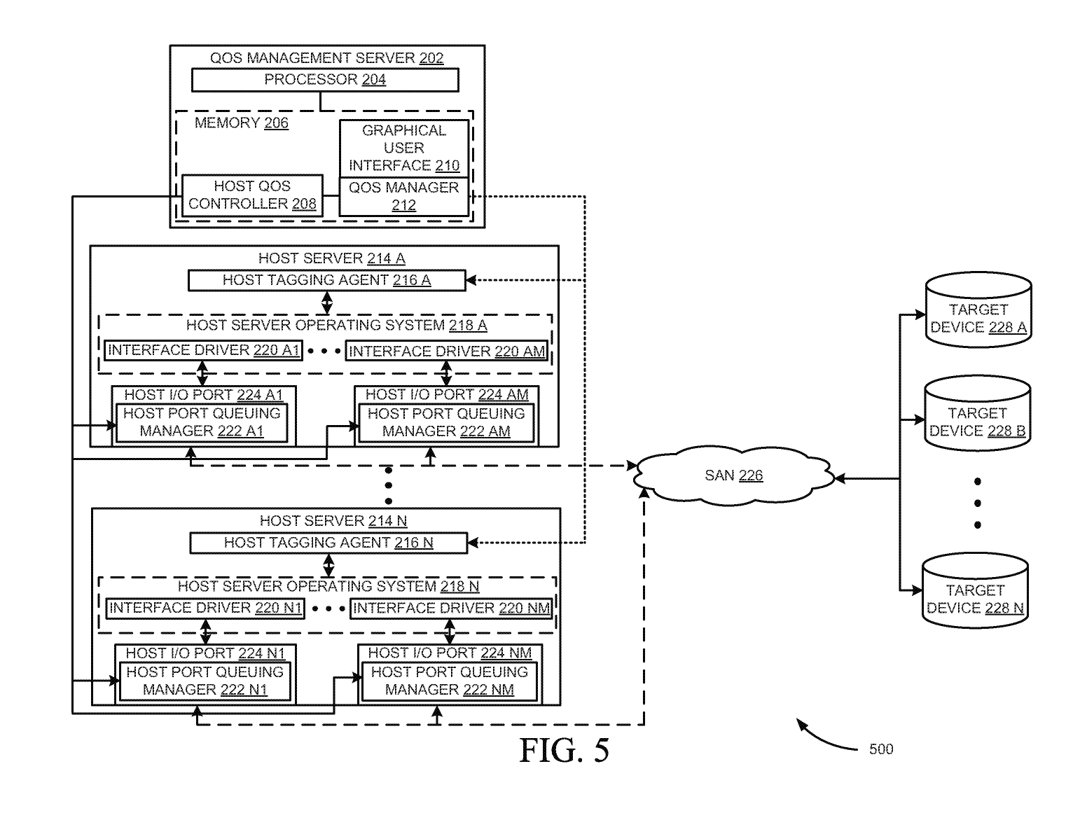

Referring now to FIG. 5, another block diagram illustrates a system 500 for the improved I/O request QoS across multiple host I/O ports using the process shown in FIG. 1, according to an embodiment. The system 500 is similar to the system 200, shown in FIG. 2, except that the system 500 illustrates the host port queuing managers 222 A1-AM to 222 N1-NM implemented in the firmware of host I/O ports 224 A1-AM to 224 N1-NM, respectively. As shown in FIG. 5, each of the interface drivers 220 A1-AM to 220 N1-NM is coupled to the associated one of the host I/O ports 224 A1-AM to 224 N1-NM in the host servers 214 A-N, respectively. Further as shown in FIG. 5, each of the host I/O ports 224 A1-AM to 224 N1-NM includes the associated one of the host port queuing managers 222 A1-AM to 222 N1-NM.

In operation, one of the host servers 214 A-N generates an I/O request associated with a classification parameter. In one embodiment, an application in one of the host servers 214 A-N generates the I/O request, where the application is associated with a QoS SLA. Further in operation, the one of the host tagging agents 216 A-N in the associated one of the host servers 214 A-N receives the I/O request associated with the classification parameter. In order to deliver the required QoS for the application, the associated one of the host tagging agents 216 A-N determines a classification value based on the classification parameter. This is explained in more detail with reference to FIG. 2.

Furthermore in operation, the classification value is associated with the I/O request by the associated one of the host tagging agents 216 A-N. The I/O request is then sent to the associated one of the interface drivers 220 A1-AM to 220 N1-NM. The associated one of the interface drivers 220 A1-AM to 220 N1-NM then sends the I/O request to the associated one of the host I/O ports 224 A1-AM to 224 N1-NM. In addition in operation, the associated one of the host port queuing managers 222 A1-AM to 222 N1-NM in the associated one of the host I/O ports 224 A1-AM to 224 N1-NM and the host QoS controller 208 prioritizes the I/O request.

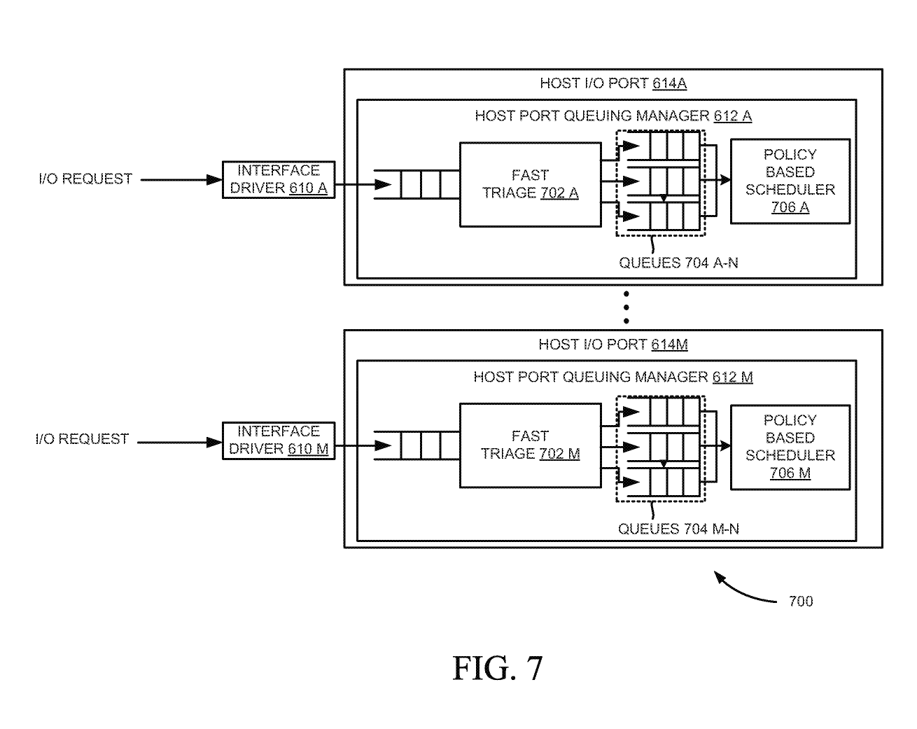

Moreover in operation, based on the priority the I/O request is queued and scheduled to be serviced in the associated one of the host port queuing managers 222 A1-AM to 222 N1-NM in the associated one of the host servers 214 A-N, respectively. This is explained in more detail with reference to FIG. 7. The I/O request is then sent to one of the plurality of target devices 228 A-N by the associated one of the host port queuing managers 222 A1-AM to 222 N1-NM. Also, the I/O request is sent to one of the plurality of target devices 228 A-N via the SAN 226.

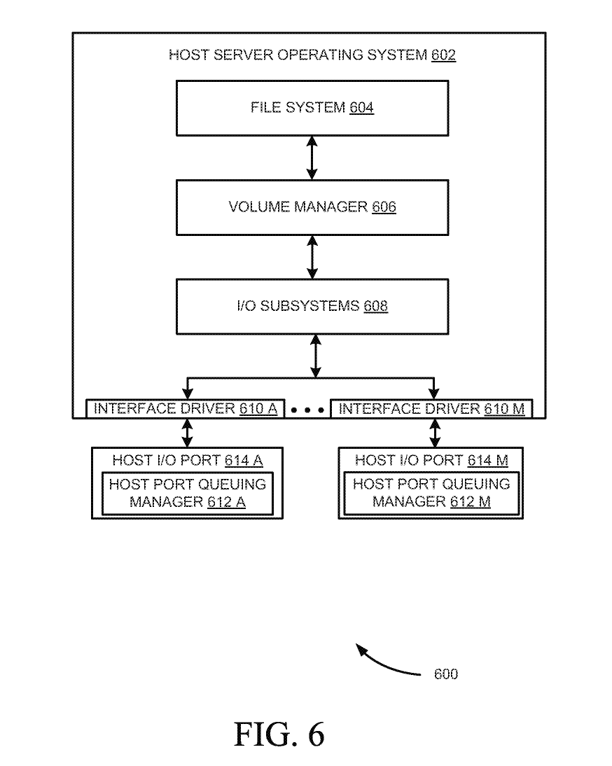

Referring now to FIG. 6, a block diagram 600 illustrates the host server operating system 602 stack layer used in the system, such as the one shown in FIG. 5, according to an embodiment. Each of the host server operating systems 218 A-N in the host servers 214 A-N, respectively, shown in FIG. 5, includes a host server operating system stack layer similar to the host server operating system 602 stack layer, shown in FIG. 6. As shown in FIG. 6, the host server operating system 602 stack layer includes a file system 604, a volume manager 606, I/O subsystems 608 and interface drivers 610 A-M. Exemplary I/O subsystems include drivers, multi-path layers and the like. Further as shown in FIG. 6, each of the interface drivers 610 A-M is coupled to one of host I/O ports 614 A-M. In this embodiment, each of the host I/O ports 614 A-M includes one of host port queuing managers 612 A-M, as shown in FIG. 6. However, one can envision, the host port queuing managers 612 A-M being implemented in the volume manager 606 or the I/O subsystems 608.

In operation, an I/O request is generated by an application in a host server associated with the host server operating system 602. In some embodiments, the I/O request can be generated by the file system 604, the volume manager 606 or the I/O subsystems 608. The generated I/O request is then sent to one of the interface drivers 610 A-M. Further in operation, the one of the interface drivers 610 A-M sends the I/O request to the associated one of the host I/O ports 614 A-M. Furthermore in operation, the one of the host port queuing managers 612 A-M in the associated one of the host I/O ports 614 A-M queues and schedules the I/O request for service. This is explained in more detail with reference to FIG. 7.

Referring now to FIG. 7, a block diagram 700 illustrates elements in host port queuing managers 612 A-M realized in the host I/O ports 614 A-M, respectively, in the host server operating system 602, such as those shown in FIG. 6, according to an embodiment. Each of the host port queuing managers 222 A1-AM to 222 N1-NM in the host servers 214 A-N, shown in FIG. 5, includes elements similar to the elements in the host port queuing managers 612 A-M, shown in FIG. 7. Particularly, FIG. 7 illustrates the interface drivers 610 A-M coupled to the associated one of the host I/O ports 614 A-M. As shown in FIG. 7, each of the host I/O ports 614 A-M includes the associated one of the host port queuing managers 612 A-M. Further as shown in FIG. 7, each of the host port queuing managers 612 A-M includes an associated one of fast triages 702 A-M, associated plurality of queues 704 A-N to 704 M-N and an associated one of policy based schedulers 706 A-M.

In operation, an I/O request associated with a classification value is received by one of the interface drivers 610 A-M. This is explained in more detail with reference to FIGS. 5 and 6. The one of the interface drivers 610 A-M then sends the I/O request to the associated one of the host port queuing managers 612 A-M. The associated one of the fast triages 702 A-M in the one of the host port queuing managers 612 A-M identifies the classification value associated with the I/O request and classifies the I/O request. Based on the classification, the I/O request is sent into one of the queues in the associated one of the plurality of queues 704 A-N to 704 M-N. For example, an I/O request received by the fast triage 702 A in the host port queuing manager 612 A is classified based on the classification value associated with the I/O request and sent into one of the queues 704 A-N.

Further in operation, the queues 704 A-N to 704 M-N are controlled by the policy based schedulers 706 A-M, respectively. Furthermore in operation, the policy based schedulers 706 A-M are controlled by the host QoS controller 208, shown in FIG. 5. In order to achieve a required SLA for an application, in one embodiment, the host QoS controller 208 skews the policy based schedulers 706 A-M. Furthermore in operation, the policy based schedulers 706 A-M controls the release rate of the I/O request in the queues 704 A-N to 704 M-N, respectively. In addition in operation, the policy based schedulers 706 A-M releases the I/O request in the associated one of the queues 704 A-N to 704 M-N, respectively, based on the classification value associated with the I/O request. The I/O request is then sent to the associated one of the target devices 228 A-N to be serviced. This is explained in detail with reference to FIG. 5.

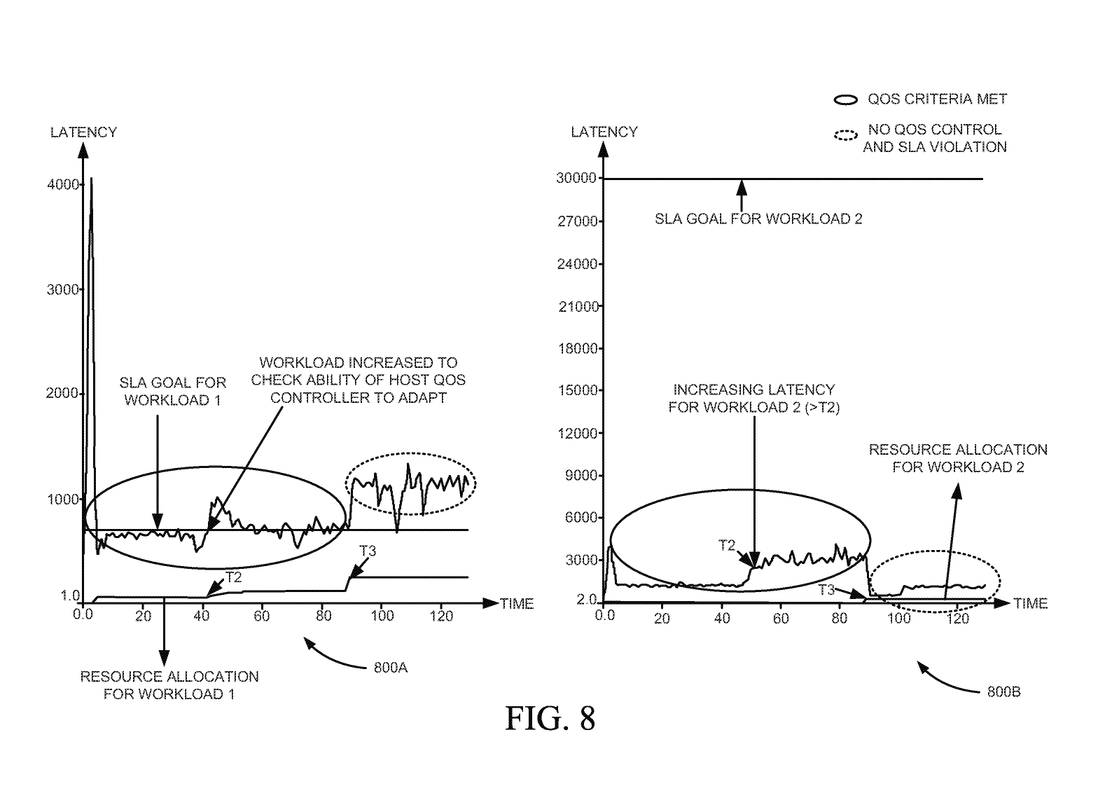

Referring now to FIG. 8, graphs 800A and 800B illustrates latency results of I/O requests plotted against tic e when using the improved I/O request quality of service (QoS) across multiple host I/O ports, such as those shown in FIGS. 2 and 5, according to an embodiment. Particularly, FIG. 8 illustrates performance plots for a workload 1 and a workload 2 in graphs 800A and 800B, respectively. For example, the workload 1 and the workload 2 can be executed on one of the host servers 214 A-N, shown in FIGS. 2 and 5.

As shown in the graphs 800A and 800B, the x-axis indicates time and the y-axis indicates latency. For example, the workload 1 has a latency goal of 700 ms and workload 2 had a latency goal of 30 seconds. Further, a SLA goal associated with each of the workload 1 and the workload 2 is indicated by a horizontal line, as shown in the graphs 800A and 800B, respectively. In this embodiment, the host QoS controller 208 is configured to have a tolerance of 5%. In other words, the host QoS controller 208 will not skew the host port queuing managers 222 A1-AM to 222 N1-NM if the SLA goal is violated up to 5%.

As shown in the graphs 800A and 800B, the workload 1 and the workload 2 start to execute at tune 0.0. Further as shown in the graph 800A, a high latency in the workload 1 is indicated by a spike in the graph, at time 0.0. Due to the high latency associated with the workload 1 and the associated SLA goal, the host QoS controller 208 skews the associated one of the host port queuing managers 222 A1-AM to 222 N1-NM to allocate resources to the workload 1. As a result, the latency associated with the workload 1 is reduced, as shown in the graph 800A. It can be seen in the graph 800A that the SLA goal for the workload 1 is achieved.

At time T2, the workload associated with the workload 1 is increased to check the ability of the host QoS controller 208 to adapt. Therefore, at time T2 it can be seen in the graph 800A that there is an increase in latency. In order to adapt to the increase in workload associated with workload 1, the host QoS controller 208 increases the resources allocated to the workload 1, at time T2, as shown in the graph 800A. Due to the increase in resource allocation to the workload 1 at time T2, the latency associated with workload 2 increases, as shown in the graph 800B. However, the SLA goal for the workload 2 is not violated due to the high latency goal associated with the workload 2.

At time T3, the host QoS controller 208 is turned off and equal number of resources is allocated to the workload 1 and the workload 2. It can be seen from the graph 800A, at time T3, that the SLA goal for the workload 1 is violated.

In various embodiments, the methods and systems described in FIGS. 1 through 8 enable to deliver application level QoS with latency and bandwidth goals across a plurality of host servers using a centralized host QoS controller.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, and/or software embodied in a machine readable medium. For example, the various electrical structure and methods may be embodied using transistors, logic gates, and electrical circuits, such as application specific integrated circ lit.

What is claimed is:

1. A method for an improved I/O (input/output) request quality of service (QoS) across multiple host I/O ports, comprising:
receiving an I/O request associated with a classification parameter, wherein the I/O request is generated by one of a plurality of host servers;
determining a classification value based on the classification parameter by a host tagging agent residing in the one of the plurality of host servers;
associating the classification value with the I/O request by the host tagging agent;
prioritizing the I/O request based on the classification value by a host port queuing manager and a host QoS controller; and
sending the I/O request to one of a plurality of target devices based on the priority by the host port queuing manager and the host QoS controller.

2. The method of claim 1, wherein prioritizing the I/O request based on the classification value by the host port queuing manager and the host QoS controller, comprises:
prioritizing the I/O request based on the classification value by the host port queuing manager residing in one of a plurality of interface drivers in an operating system of the one of the plurality of host servers.

3. The method of claim 1, wherein prioritizing the I/O request based on the classification value by the host port queuing manager and the host QoS controller, comprises:
prioritizing the I/O request based on the classification value by the host port queuing manager residing in one of a plurality of host I/O ports in the one of the plurality of host servers.

4. The method of claim 1, further comprising:
storing classification values in the plurality of host servers for the I/O request associated with the classification parameter by a QoS manager.

5. The method of claim 1, wherein, in sending the I/O request to one of the plurality of target devices, the one of the plurality of target devices are selected from the group consisting of storage devices, network devices and processors.

6. The method of claim 1, wherein sending the I/O request to one of the plurality of target devices based on the priority by the host port queuing manager and the host QoS controller, comprises:
sending the I/O request to one of the plurality of target devices via a storage area network (SAN) based on the priority by the host port queuing manager and the host QoS controller.

7. A system for an improved I/O request quality of service (QoS) across multiple host I/O ports, comprising:
a QoS management server to implement a host QoS controller;
a host server coupled to the QoS management server to implement a host tagging agent and a plurality of interface drivers, wherein each of the interface drivers comprises a host port queuing manager;
a storage area network (SAN) coupled to the host server; and
a plurality of target devices coupled to the SAN,
wherein the host server generates an I/O request associated with a classification parameter, wherein the host tagging agent receives the generated I/O request associated with the classification parameter and determines a classification value based on the classification parameter, wherein the host tagging agent associates the classification value with the I/O request, wherein the host port queuing manager of at least one of the interface drivers and the host QoS controller prioritizes the I/O request based on the classification value, and wherein the host port queuing manager of at least one of the interface drivers and the host QoS controller sends the I/O request to one of the plurality of target devices based on the priority.

8. The system of claim 9, wherein the QoS management server further comprises a QoS manager and wherein the QoS manager stores classification values in the plurality of host servers for the I/O request associated with the classification parameter.

9. The system of claim 8, wherein the one of the plurality of target devices are selected from the group consisting of storage devices, network devices and processors.

10. The system of claim 9, wherein the host port queuing manager and the host QoS controller sends the I/O request to one of the plurality of target devices via the SAN based on the priority.

11. A system for an improved I/O request quality of service (QoS) across multiple host I/O ports, comprising:
a QoS management server to implement a host QoS controller;
a host server coupled to the QoS management server to implement a host tagging agent and a plurality of host I/O ports, wherein each of the host I/O ports comprises a host port queuing manager;
a storage area network (SAN) coupled to the host server; and
a plurality of target devices coupled to the SAN and wherein the host server generates an I/O request associated with a classification parameter, wherein the host tagging agent receives the generated I/O request associated with the classification parameter and determines a classification value based on the classification parameter, wherein the host tagging agent associates the classification value with the I/O request, wherein the host port queuing manager of at least one of the host I/O ports and the host QoS controller prioritizes the I/O request based on the classification value, and wherein the host port queuing manager of at least one of the host I/O ports and the host QoS controller sends the I/O request to one of the plurality of target devices based on the priority.

12. The system of claim 13, wherein the QoS management server further comprises a QoS manager and wherein the QoS manager stores classification values in the plurality of host servers for the I/O request associated with the classification parameter.

13. The system of claim 13, wherein the host tagging agent determines the classification value based on the classification parameter and a previous classification value assigned to the I/O request.

14. The system of claim 13, wherein the one of the plurality of target devices are selected from the group consisting of storage devices, network devices and processors.

15. The system of claim 13, wherein the host port queuing manager and the host QoS controller sends the I/O request to one of the plurality of target devices via the SAN based on the priority.
